(19) United States
(12) Patent Application Publication
(10) Pub. No.: US 2024/0289635 A1
(43) Pub. Date: Aug. 29, 2024

(54) LEARNING SYSTEM, METHOD AND NON-TRANSITORY COMPUTER READABLE MEDIUM

(71) Applicant: KABUSHIKI KAISHA TOSHIBA, Tokyo (JP)

(72) Inventors: Albert RODRIGUEZ MULET, Kawasaki Kanagawa (JP); Shuhei NITTA, Tokyo (JP); Ryusuke HIRAI, Tokyo (JP); Yasutaka FURUSHO, Fuchu Tokyo (JP)

(73) Assignee: KABUSHIKI KAISHA TOSHIBA, Tokyo (JP)

(21) Appl. No.: 18/484,949

(22) Filed: Oct. 11, 2023

(30) Foreign Application Priority Data
Feb. 24, 2023 (JP) 2023-027544

(51) Int. Cl. G06N 3/098

(52) U.S. Cl. CPC G06N 3/098

(57) ABSTRACT

According to one embodiment, a learning system includes a plurality of local devices and a server. The plurality of local devices each includes processing circuitry configured to determine a federated local training condition indicating a training condition in federated learning of a local model based on preliminary local training information including a preliminary local training condition and a preliminary local training result in a case where a model is preliminarily trained using local data. The server includes processing circuitry configured to determine a global training condition of a global model based on the preliminary local training information.

### CROSS-REFERENCE TO RELATED APPLICATIONS

This application is based upon and claims the benefit of priority from Japanese Patent Application No. 2023-027544, filed Feb. 24, 2023, the entire contents of which are incorporated herein by reference.

### FIELD

Embodiments described herein relate generally to a learning system, a method and a non-transitory computer readable medium.

### BACKGROUND

Machine learning models (local models) are trained based on training data obtained by a plurality of respective local devices, and parameters of the trained local models are transmitted to a server. In the server, parameters of the local models are aggregated and integrated, and a machine learning model (global model) that exists in the server is updated. Parameters of the updated global model are distributed to each of the plurality of local devices. There is a training method called federated learning in which such a series of processing is repeated. In federated learning, training is performed in a plurality of local devices, so that the computational load can be distributed. Furthermore, since only parameters are exchanged with the server, there is no exchange of training data itself. Therefore, there is an advantage that privacy confidentiality is high and communication cost is low.

In a case where a neural network is used as a machine learning model, it is important to appropriately set a training condition (balancing parameter) including a learning rate, a regularization strength, an optimizer, and the like. In federated learning, a training condition of local models and a training condition of a global model need to be set according to the number of devices, and it is difficult to appropriately set these values as the number of devices increases.

### BRIEF DESCRIPTION OF THE DRAWINGS

FIG. 1 is a conceptual diagram illustrating a learning system according to the present embodiment.

FIG. 2 is a flowchart illustrating training processing of the learning system according to the present embodiment.

FIG. 3 is a block diagram illustrating an example of a hardware configuration of a local device and a server.

### DETAILED DESCRIPTION

In general, according to one embodiment, a learning system includes a plurality of local devices and a server. The plurality of local devices each includes processing circuitry configured to determine a federated local training condition indicating a training condition in federated learning of a local model based on preliminary local training information including a preliminary local training condition and a preliminary local training result in a case where a model is preliminarily trained using local data. The server includes processing circuitry configured to determine a global training condition of a global model based on the preliminary local training information.

Hereinafter, a learning system, method and non-transitory computer readable program according to the present embodiment will be described in detail with reference to the drawings. Note that, in the following embodiment, portions denoted by the same reference signs perform the same operation, and redundant description will be appropriately omitted.

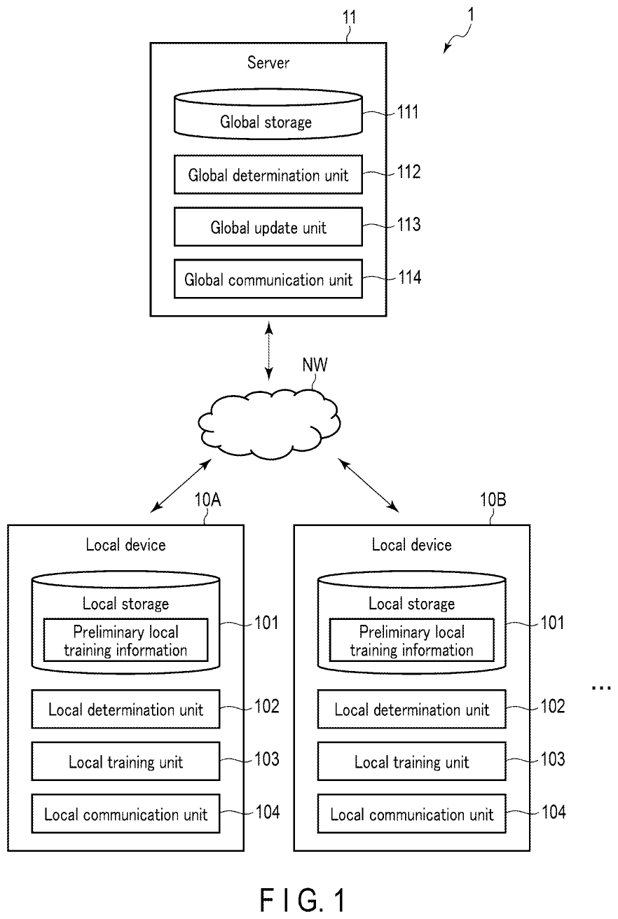

A learning system according to the present embodiment will be described with reference to a block diagram of FIG. 1.

The learning system according to the present embodiment includes a local device 10A, a local device 10B, and a server 11, which are connected to each other so as to be able to transmit and receive data via a network NW. Here, two local devices 10A and 10B are illustrated as an example, but three or more local devices 10 may be included. Hereinafter, in the case of description common to each of the local devices, it is simply referred to as a local device 10.

Each local device 10 includes a local storage 101, a local determination unit 102, a local training unit 103, and a local communication unit 104.

The local storage 101 stores local data, a local model, a trained model, and the like in addition to preliminary local training information. The preliminary local training information is information obtained in preliminarily training a model only using the local data held by each local device 10, and includes a preliminary local training condition and a preliminary local training result that is a training result based on the preliminary local training condition.

The preliminary local training condition is a training condition for training a model preliminarily, and includes, for example, a learning rate, a regularization, a mini-batch size, an initialization method or a model weight, an optimizer, classification information of a data set, and a setting regarding an architecture structure. The learning rate is, for example, an initial learning rate or a learning rate schedule. The regularization is, for example, an L1 regularization strength, an L2 regularization strength, a dropout number, an orthogonal regularization strength, or a schedule thereof. The initialization method or the model weight is, for example, information regarding a random number or a lottery hypothesis. The optimizer is, for example, an update formula such as stochastic gradient decent (SGD), Adam, or layer-wise adaptive rate scaling (LARS), or a balancing parameter thereof. The distribution information of a data set is, for example, a quantification value of the nature and difficulty of data obtained by the number of pieces of the data, an average value, a variance value, the Shannon information amount, V-usable information, and the like. The architecture structure indicates what type of structure the model to be used has, and is, for example, a structure of a model having a skip structure such as convolutional neural network (CNN), support vector machine (SVM), random forest, or ResNet, DenseNet, or U-net. Note that a structure suitable for a task is required to be selected as the architecture structure.

The preliminary local training result includes a model recognition rate, a loss, a pruning result, and a neural tangent kernel (NTK) information. Each of the recognition rate and the loss of a model indicates a result regarding a recognition rate curve of each of the last round of the local data and test data that are training data, a round in which the best performance was obtained, and an intermediate stage. The pruning result indicates weights, channels, and layers that can be deleted by a neural network during or after training. The NTK information indicates information of a kernel indicating how the entire weight of the neural network during training or its feature changes or the like.

The preliminary local training information is a baseline before execution of federated learning for a user or an administrator who holds each local device 10, and is important information for checking a performance improvement status by federated learning and estimating target performance. Therefore, by the preliminary local training condition being appropriately set and appropriate preliminary local training being executed, further effects can be expected in the subsequent federated learning.

In the present embodiment, the local data is, for example, an inspection image of a manufactured product of a factory. For example, in a case where the local data is an inspection image, a local label is a category classification of a defect (scratch, dirt, deformation, or the like) associated with the inspection image.

The local model is, for example, a neural network, and is trained so as to be able to execute a classification task of classifying an inspection image into a non-defective product and a defective product in the case of an inspection image. Note that the task of the local model is not limited to a classification task, and may be any task such as object detection, semantic segmentation, motion recognition, anomaly detection, suspicious person detection, regression, or prediction. Furthermore, the local data is not limited to an image, and may be time-series data such as speech, operation sound such as machine sound, environmental sound, acceleration data, and meter data, and may be any data as long as the data can be handled by machine learning.

The local determination unit 102 acquires the preliminary local training information, and determines a federated local training condition based on the preliminary local training information. The federated local training condition is a condition for training the local model using the local data in a case where the federated learning method is used.

The local training unit 103 updates the local model based on the federated local training condition. Furthermore, in a case of performing preliminary training, the local training unit 103 updates the local model by training the local model using the local data based on the preliminary local training condition. As a result, the preliminary local training result can be obtained as a training result of the model, and the preliminary local training information including the preliminary local training condition and the preliminary local training result can be generated.

The local communication unit 104 transmits local model parameters and the preliminary local training information regarding the updated local model to the server 11. The local model parameters are parameters (weighting factor, bias, and the like) of the neural network for sharing parameters with the global model. Furthermore, the local communication unit 104 receives information regarding the global model from the server 11. The information regarding the global model is, for example, parameters of the global model.

The server 11 includes a global storage 111, a global determination unit 112, a global update unit 113, and a global communication unit 114.

The global storage 111 stores the global model. The global model is, for example, a neural network.

The global determination unit 112 determines a global training condition using the preliminary local training information received from a plurality of local devices 10.

The global update unit 113 determines an integration parameter based on the global training condition and the local model parameters, and updates the global model. The integration parameter is a parameter representing an aggregation ratio of the local model parameters received from the local devices 10.

The global communication unit 114 receives the local model parameters and the preliminary local training information from a plurality of local devices 10. The global communication unit 114 transmits information regarding the updated global model to each of the local devices 10.

Note that examples of the local models and the global model include a CNN, a multilayer perceptron (MLP), a recurrent neural network (RNN), a transformer, and bidirectional encoder representations from transformer (BERT), and a neural network having an architecture structure used in other general machine learning may be used as the local models and the global model. Furthermore, the present invention is applicable not only to a neural network but also to all machine learning models to which federated learning is applicable. For example, a model such as SVM or random forest may be used.

Note that parameters included in the preliminary local training information are also appropriately balanced depending on the type of the machine learning model. Specifically, in the case of SVM, a penalty coefficient and a tolerance are included in the preliminary local training information, and in the case of random forest, the number of trees, the maximum depth, and the like are included in the preliminary local training information.

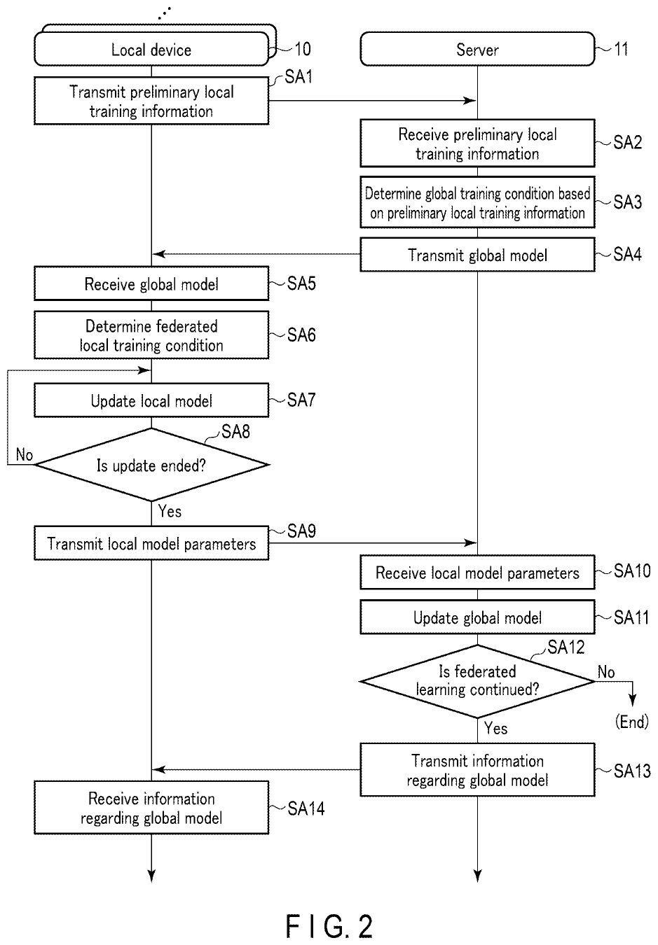

Next, training processing of the learning system 1 according to the present embodiment will be described with reference to the sequence diagram of FIG. 2. Note that, unless otherwise described, each of the plurality of local devices 10 is assumed to execute processing according to the sequence diagram.

Furthermore, in the present embodiment, a state in which the preliminary local training information was already obtained is assumed, but a model may be preliminarily trained using the preliminary local training condition at the stage of executing the training processing of the learning system 1 according to the present embodiment, and the preliminary local training information may be acquired.

In step SA1, the local communication unit 104 of the local device 10 transmits the preliminary local training information in which the preliminary local training condition and the preliminary local training result are associated with each other to the server 11.

In step SA2, the global communication unit 114 of the server 11 receives the preliminary local training information.

In step SA3, the global determination unit 112 of the server 11 determines the global training condition based on the preliminary local training information. The global training condition is a training condition regarding federated learning including an architectural structure of the global model, a condition at the time of updating the global model, and a condition at the time of integrating the local model parameters. For example, in a case where the initial value of the global model is set, it is assumed that a result in which a high recognition rate was obtained by initializing a weight parameter of the local model using HeNormal was obtained in the preliminary local training information. In this case, by a parameter of the global model being similarly initialized using HeNormal, achievement of a high recognition rate can be expected even in federated learning.

Furthermore, as the structure of the global model, an individualization method for considering a difference in data distribution between the local devices 10 may be adopted. In this case, the global determination unit 112 may determine the global training condition such that the global model is updated while conversion according to the individualization method being executed.

For example, by a vector norm or a singular value of a matrix regarding a parameter of a trained model included in the preliminary local training result being analyzed, an unnecessary model structure and an expression capability (capacity) necessary for a local model can be estimated. Therefore, for example, by the number of layers that are not integrated at the time of execution of federated learning and are individualization layers unique to the local device being designed in proportion to the expression capability required in the local model, federated learning capable of providing an optimal model structure (scale) for each local device 10 is executed. Note that it is more beneficial in a case where the preliminary local training condition is determined according to a method suitable for structural analysis (pruning) of the local model.

Furthermore, the difficulty level of the task and the optimal scale of the neural network (for example, number of parameters, number of channels, and number of layers) are in a proportional relationship. That is, federated learning can be executed while the optimal model structure (scale) for each local device 10 being provided by the number of layers of the individualization layers being designed in proportion to performance (recognition rate or the like) obtained from the preliminary local training result since the scale of the neural network is desirably increased in a case where the task is difficult.

In a case where the difficulty level of the task is different for each local device 10, parameter update for a simpler task is prioritized in federated learning, and the training result of each local device 10 may not be reflected in a balanced manner. In that case, for example, by a weighted average of the parameters of each local model being taken and integrated, a weighting factor at the time of updating the global model may be set to a value inversely proportional to the performance (test recognition rate) of the preliminary local training result or an index for quantifying the task difficulty level (for example, Shannon information amount or V-usable Information). As a result, a training result of each local device 10 can be reflected in a well-balanced manner.

In step SA4, the global communication unit 114 of the server 11 transmits the global model to each local device 10. The global model transmitted here is, for example, a set of parameters of a neural network shared with the local device 10.

In step SA5, the local communication unit 104 of the local device 10 receives the global model from the server 11.

In step SA6, the local determination unit 102 of the local device 10 determines the federated local training condition based on the preliminary local training information. For example, model parameters that are not shared with the server 11, such as the above-described individualization layers, can reflect knowledge at the time of preliminary training by being initialized by the same initialization method as initialization of the preliminary local training condition or by being initialized using model parameters of the trained model that is a result of the preliminary training.

Furthermore, in general, the smoothness (loss landscape) of the loss with respect to the model parameters changes depending on a combination of values of the learning rate, the regularization strength, the batch size, the data augmentation method, and the like, and thus, setting needs to be appropriately performed according to the environment such as the difficulty level of the task. In the present embodiment, for example, a value that is the same as or proportional to the preliminary local training condition may be determined as the federated local training condition.

Furthermore, the regularization strength and the degree of data augmentation vary depending on a task, and are generally set to be strong in a case where over-fitting (over-learning) is desirably avoided, and to be weak in a case where over-fitting is not desirably avoided. It is known that, also for an optimizer, a suitable optimization function varies depending on a task. For example, SGD is suitable for an image classification task, and Adam is suitable for a generation task such as a GAN. Furthermore, even in the same optimizer, values of optimal balancing parameters (momentum, epsilon, and the like) are different. Therefore, by the federated local training condition being calculated based on the preliminary local training information, an enormous number of combinations of balancing parameters can be efficiently selected.

Note that the number of repetitions related to update of the local model at the time of training included in the federated local training condition may be determined based on the preliminary local training result. There is a trade-off that, while the calculation cost can be reduced as the number of repetitions of training increases, the update width of each local model increases at the time of updating the global model of the server 11, and integration processing cannot be efficiently performed. Therefore, the local determination unit 102 of the local device 10 sets the number of repetitions such that the number is inversely proportional to, for example, the learning curve of the preliminary local training result, here, the loss and the change rate of the recognition rate. As a result, update of the global model can be stabilized by the number of repetitions being reduced at a training timing of a local device in which the training progress is early, and the calculation cost can be reduced by the number of repetitions being increased at a training timing of a local device in which the training progress is late.

In step SA7, the local training unit 103 of the local device 10 updates the local model by training the local model based on the determined federated local training condition. Here, K (1≤ K≤N) local devices are selected from all the local devices 10, and caused to execute training. It should be noted that in a case where K=N is satisfied, there is an advantage that update information of the local models of all the local devices 10 can be considered at the time of updating the global model of the server 11, but the communication cost and calculation cost increase. Since performance can be maintained even in a case where K is about 10% of N in many cases, K may be set to a value smaller than N.

Specifically, an input image input to a local model is defined as x→ᵢⱼ (i=1, 2, 3, . . . , j=1, . . . , Nᵢ). Here, a superscript arrow indicates that data to which an arrow is assigned is tensor data. i is a serial number identifying the local devices 10, j is a serial number of pieces of training data, and Nᵢ is a natural number greater than or equal to two, representing the number of pieces of training data obtained by sampling in the i-th local device 10. Furthermore, the input image x→ᵢⱼ is a pixel set having a horizontal width W and a vertical width H, and is two-dimensional tensor data.

A target label for the input image x→ᵢⱼ is represented as t→ᵢⱼ. The target label t→ᵢⱼ is an M-dimensional vector in which a corresponding element is 1 and other elements are zero. M is the number of classification types, and is a natural number of two or more. For example, in a case where the input image x→ᵢⱼ is a product image, a case where there is a defect can be expressed as (1, 0)^{T}, and a case where there is no defect can be expressed as (0, 1)^{T}. Here, the superscript T represents a column vector.

In a case where an input to a local model is the input image x→ᵢⱼ and an output of the local model is y→ᵢⱼ, the local model can be expressed by Formula (1).

$${y}_{ij}^{\to } = f ( {x}_{ij}^{\to } ) \qquad ( 1 )$$

Here, f( ) represents a function of the neural network regarding the local model.

Furthermore, a learning error Lᵢⱼ is expressed by Formula (2).

$${L}_{ij} = - {{t}_{ij}^{\to }}^{T} ln ( {y}_{ij}^{\to } ) \qquad ( 2 )$$

Here, the learning error Lᵢⱼ is calculated using the cross entropy. In each local device 10, the local training unit 103 calculates, for example, an average of learning errors of each of a plurality of input images related to the mini-batch as a loss, and updates parameters of the neural network regarding the local model by a back propagation method and a stochastic gradient descent method so as to minimize the loss.

As described above, at the time of updating the local model, an individualization method for each local device 10 such as meta-learning or distillation may be adopted. For example, an input layer of each local model may be set as a layer including a parameter unique to each local model, or some of intermediate layers may be set as layers including a parameter unique to each local model. Furthermore, in a case where each local model includes a normalization layer, the normalization layer may be a layer including a parameter unique to the local model. As described above, instead of directly copying the received global model to the local model, the global model may be converted according to a personalization technique and the local model may be updated.

In step SA8, the local training unit 103 of the local device 10 determines whether update of the local model was ended. For example, the update may be determined to be ended in a case where the update was performed for the number of repetitions set based on the federated local training condition. Note that the update may be determined to be ended in a case where an absolute value of the update amount of the parameters or the sum of absolute values reaches a constant value. The determination as to whether the update was ended is not limited to the above-described example, and an end condition generally adopted in machine learning may be used. In a case where the update of the local model was ended, the processing proceeds to step SA9, and in a case where the update of the local model was not ended, the processing returns to step SA7 and similar processing is repeated.

In step SA9, the local communication unit 104 of the local device 10 transmits the local model parameters regarding the local model for which the update was ended to the server 11. The local model parameters may be, for example, parameters after the update, or may be change amounts due to the update, for example, differences between the parameters before the update and the parameters after the update. Furthermore, the local communication unit 104 may compress and transmit data regarding the parameters to be transmitted to the server 11. The data compression processing may be lossless compression or lossy compression. By the data being compressed and transmitted, the communication amount and the communication band can be saved. Furthermore, the data may be encrypted and transmitted, and the confidentiality of the data can be improved.

In step SA10, the global communication unit 114 of the server 11 receives the local model parameters from each local device 10.

In step SA11, the global update unit 113 of the server 11 updates the global model based on the local model parameters and the global training condition. The global model needs to be updated by the local model parameters of each local device 10 being integrated, and can be expressed by, for example, Formula (3).

$${Θ}_{g} = {\sum }_{i ∈ S} ( {a}_{i} x {Θ}_{i} ) \qquad ( 3 )$$

Θ_{g} is a model parameter (global model parameter) of the global model. S is a serial number of the updated K devices. Θᵢ is a model parameter excluding the individualization layers of the local model. aᵢ is an integration parameter representing an aggregation ratio of the local model parameters, in other words, a weighting factor related to each local model. aᵢ is determined in step SA5. Note that a general update method in federated learning may be applied to the global model update method as long as it follows the global training condition.

In step SA12, the global update unit 113 of the server 11 determines whether to continue the federated learning. For whether to continue the federated learning, the federated learning may be determined not to be continued on the assumption that the federated learning was ended, for example, in a case where performance of the local model such as a recognition rate, an accuracy, a precision, and a recall of each local device 10 achieved a target value, in a case where the global model was updated for a predetermined number of times of update, or in a case where an update width of the global model was converged to a threshold or less. In a case where the federated learning is not continued, the federated learning is ended, and in a case where the federated learning is continued, the processing proceeds to step SA13.

In step SA13, the global communication unit 114 of the server 11 transmits information regarding the global model to each local device 10. The information regarding the global model is, for example, at least one of a global model body, a global model parameter after the update, or a change amount due to the update.

In step SA14, the local communication unit 104 of the local device 10 receives the information regarding the global model from the server 11. Thereafter, the learning system 1 may repeatedly execute the processing from step SA4 to step SA14 until the federated learning is ended.

Note that the number of times of update of the global model (also referred to as the number of global iterations) needs to be appropriately set according to the expression capability of the global model or the task difficulty level of each local device 10. In a case where the number of times of update is too small, performance may not be achieved, and in a case where the number of times of update is too large, redundant calculation cost and communication cost may occur, or performance deterioration may be caused due to over-learning. Therefore, for example, a value proportional to the maximum value, the median value, the average value, or the like of the number of training epochs included in the preliminary local training condition of each local device 10 is set as the number of times of update of the global model. As a result, the appropriate number of times of update of the global model can be set.

Furthermore, local devices 10 participating in the federated learning may be grouped into a plurality of groups, and federated learning may be performed for each of the groups.

For example, federated learning can be more efficiently implemented by a local device group participating in the federated learning being grouped and the federated learning being applied for each of the groups rather than by federated learning being applied to a plurality of local devices 10 having extremely different local data distributions, task difficulty levels, optimal conditions, and the like. For example, since the global determination unit 112 of the server 11 can extract local devices 10 having similar situations from the preliminary local training condition (for example, learning rate and optimizer) and the preliminary local training result (recognition rate, loss), the local devices 10 having similar situations may be grouped and federated learning may be applied for each of the groups.

Furthermore, the global determination unit 112 of the server 11 may refer to the preliminary local training information, and in a case where there is a local device 10 having a small number of epochs (number of repetitions) of training, the probability of executing update processing of the local model in step SA7 in the federated learning may be set low. As a result, a high recognition rate can be achieved while the communication cost and the training time of the local device 10 and the entire federated learning being reduced and the local device 10 being updated using a small number of epochs.

Note that, although it is assumed that all the local devices 10 are in the same recognition category (for example, classification of articles) in the classification task, and perform training using local data of the same image size in the above-described embodiment, the recognition category or the data size may be different between the local devices 10. For example, in a case where the recognition category is different, an output layer individualized according to the number of output channels needs to be prepared. As a result, training can be performed in accordance with the number of recognition categories while knowledge of images being utilized. Furthermore, in a case where the image size as the data size is different, the width (the number of channels) and the depth of the neural network need to be individualized. As a result, training can be performed according to the receptive field of an image.

Furthermore, in the above-described embodiment, it was assumed that the federated local training condition and the global training condition are calculated based on the preliminary local training information at the stage of starting federated learning, and the same federated local training condition and global training condition are used during execution of the federated learning, but the present invention is not limited thereto. For example, a change may be appropriately made in a training process of the federated learning such that the federated local training condition and the global training condition are corrected based on the preliminary local training information and a training progress of federated learning being executed at the timing at which update of the global model ends. Specifically, for example, in the aggregation ratio (integration parameter), a local device 10 having a larger deviation from the preliminary local training result is set to have a larger weight, so that a local device 10 in which training is delayed is prevented from occurring.

Furthermore, in the above-described embodiment, it is assumed that the local models of the local devices 10 and the global model of the server 11 are basically neural networks having the same structure, but each of the local models of the plurality of local devices 10 may be a scalable neural network that shares some of the parameters with the neural network of the global model. The scalable neural network is a neural network capable of balancing a model size such as the number of convolution layers of a network model according to a required operation amount or performance. For example, a case where the local models are different in the local devices 10 indicates that the model structure and the model size, the weighting factor, the number of parameters such as bias, and the like are different. The server 11 may update the parameter of the global model and transmit a part of the global model to each of the local devices 10 according to the scale of each of the local models.

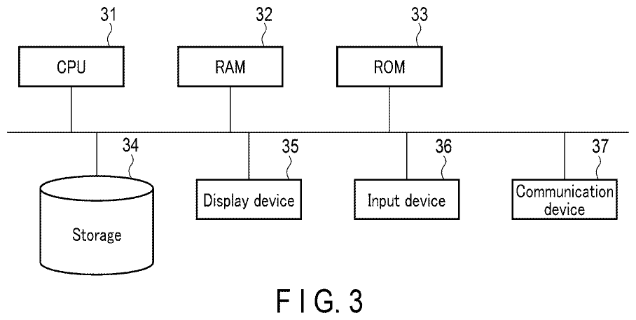

Here, an example of a hardware configuration of a local device 10 and the server 11 according to the above-described embodiment is illustrated in the block diagram of FIG. 3.

The local device 10 and the server 11 include a central processing unit (CPU) 31, a random access memory (RAM) 32, a read only memory (ROM) 33, a storage 34, a display apparatus 35, an input apparatus 36, and a communication apparatus 37, which are each connected by a bus.

The CPU 31 is a processor that executes arithmetic processing, control processing, and the like according to a program. The CPU 31 uses a predetermined area of the RAM 32 as a work area, and executes processing of each unit of the local device 10 and the server 11 described above in cooperation with a program stored in the ROM 33, the storage 34, and the like.

The RAM 32 is a memory such as a synchronous dynamic random access memory (SDRAM). The RAM 32 functions as a work area of the CPU 31. The ROM 33 is a memory that stores a program and various types of information in a non-rewritable manner.

The storage 34 is an apparatus that writes and reads data in and from a magnetic recording medium such as a hard disc drive (HDD), a semiconductor storage medium such as a flash memory, an optically recordable storage medium, or the like. The storage 34 writes and reads data to and from the storage medium under the control of the CPU 31.

The display apparatus 35 is a display device such as a liquid crystal display (LCD). The display apparatus 35 displays various types of information based on a display signal from the CPU 31.

The input apparatus 36 is an input device such as a mouse and a keyboard. The input apparatus 36 receives information input by an operation from a user as an instruction signal, and outputs the instruction signal to the CPU 31.

The communication apparatus 37 communicates with an external device via a network under the control of the CPU 31.

The instructions indicated in the processing procedure indicated in the above-described embodiment can be executed based on a program that is software. By this program being stored in advance and this program being read, a general-purpose computer system can obtain an effect similar to the effect of control operation of the learning system (local devices and server) described above. The instructions described in the above-described embodiment are recorded in a magnetic disk (flexible disk, hard disk, or the like), an optical disk (CD-ROM, CD-R, CD-RW, DVD-ROM, DVD+R, DVD+RW, Blu-ray (registered trademark) Disc, or the like), a semiconductor memory, or a recording medium similar thereto as a program that a computer can be caused to execute. The storage format may be any form as long as it is a recording medium readable by a computer or an embedded system. In a case where the computer reads a program from the recording medium and causes the CPU to execute an instruction described in the program based on the program, operation similar to control of the learning system (local devices and server) of the above-described embodiment can be implemented. Of course, in a case where the computer acquires or reads the program, the program may be acquired or read through a network.

Furthermore, an operating system (OS) running on the computer, database management software, middleware (MW) such as a network, or the like based on an instruction of the program installed from the recording medium to the computer or the embedded system may execute a part of each portion of processing for implementing the present embodiment.

Furthermore, the recording medium in the present embodiment is not limited to a medium independent of the computer or the embedded system, and includes a recording medium that downloads and stores or temporarily stores a program transmitted via a LAN, the Internet, or the like.

Furthermore, the number of recording media is not limited to one, and a case where the processing in the present embodiment is executed from a plurality of media is also included in the recording medium in the present embodiment, and the configuration of the medium may be any configuration.

Note that the computer or the embedded system in the present embodiment is for executing each portion of processing in the present embodiment based on the program stored in the recording medium, and may have any configuration such as an apparatus including one of a personal computer, a microcomputer, or the like, a system in which a plurality of apparatuses is connected to a network, or the like.

Furthermore, the computer in the present embodiment is not limited to a personal computer, and includes an arithmetic processing apparatus, a microcomputer, or the like included in an information processing device, and collectively refers to a device and an apparatus capable of implementing a function in the present embodiment by a program.

According to the present embodiment described above, the federated local training condition and the global training condition in federated learning are determined using the preliminary local training information including a preliminary training condition and a training result obtained by preliminary training performed by a local device. As a result, many federated learning conditions in which local data of each local device is considered, for example, the nature and difficulty level of the local data are considered can be appropriately set.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning system comprising a plurality of local devices and a server,
the plurality of local devices each comprising processing circuitry configured to determine a federated local training condition indicating a training condition in federated learning of a local model based on preliminary local training information including a preliminary local training condition and a preliminary local training result in a case where a model is preliminarily trained using local data, and
the server comprising processing circuitry configured to determine a global training condition of a global model based on the preliminary local training information.

2. The system according to claim 1, wherein the server includes the processing circuitry further configured to integrate a parameter of the local model received from each of the local devices and update the global model based on the global training condition, and
each of the local devices includes the processing circuitry further configured to update the local model based on a parameter regarding the updated global model.

3. The system according to claim 1, wherein the preliminary local training condition includes information regarding at least one of a learning rate, a regularization, a mini-batch size, an initialization method, an optimizer, and selection of an architecture structure, regarding the local model.

4. The system according to claim 1, wherein the preliminary local training result includes information regarding at least one of a recognition rate, a loss, a learning curve, a weight of a model, and a pruning result, in a case where the local model is trained using the preliminary local training condition.

5. The system according to claim 1, wherein the global training condition includes information of an individualization layer of a local model based on a difference in data distribution between the local devices.

6. The system according to claim 1, wherein the server includes the processing circuitry further configured to:
group, as a local device group, a plurality of local devices each including a similar data distribution or training situation based on the preliminary local training information;
determine information regarding the local device group as the global training condition; and
perform the federated learning for each of the local device group based on the global training condition.

7. The system according to claim 1, wherein the preliminary local training information includes a number of training epochs, and
the server includes the processing circuitry further configured to set a number of times of update of the global model based on the number of training epochs.

8. The system according to claim 1, wherein each of the local device includes the processing circuitry further configured to correct the federated local training condition based on the preliminary local training information and a training progress of the federated learning.

9. The system according to claim 1, wherein the server includes the processing circuitry further configured to correct the global training condition based on the preliminary local training information and a training progress of the federated learning.

10. A learning method of a learning system including a plurality of local devices and a server, the learning method comprising:
determining a federated local training condition indicating a training condition in federated learning of a local model based on preliminary local training information including a preliminary local training condition and a preliminary local training result in a case where a model is preliminarily trained using local data, and
determining a global training condition of a global model based on the preliminary local training information.

11. A non-transitory computer readable medium including computer executable instructions, wherein the instructions, when executed by a processor, cause the processor to perform a method comprising:
determining a federated local training condition indicating a training condition in federated learning of a local model based on preliminary local training information including a preliminary local training condition and a preliminary local training result in a case where a model is preliminarily trained using local data, and
determining a global training condition of a global model based on the preliminary local training information.
